(19) United States
(12) Patent Application Publication
(10) Pub. No.: US 2023/0264590 A1
(43) Pub. Date: Aug. 24, 2023

(54) MOTOR VEHICLE

(71) Applicant: TOYOTA JIDOSHA KABUSHIKI KAISHA, Toyota-shi (JP)

(72) Inventors: Fumiyoshi KURIBARA, Toyota-shi (JP); Masanori KOASHI, Toyota-shi (JP)

(73) Assignee: TOYOTA JIDOSHA KABUSHIKI KAISHA, Toyota-shi (JP)

(21) Appl. No.: 18/172,817

(22) Filed: Feb. 22, 2023

(30) Foreign Application Priority Data
Feb. 24, 2022 (JP) 2022-026496

(51) Int. Cl. B60L 53/62; B60L 53/66

(52) U.S. Cl. CPC B60L 53/62; B60L 53/66

(57) ABSTRACT

The motor vehicle includes a power storage device, a charger that charges the power storage device with electric power from an external power source, and a control device that controls the charger. The control device acquires a charging start impossible factor that cannot start charging when the charging of the power storage device by the charger cannot be started.

### CROSS-REFERENCE TO RELATED APPLICATIONS

The present disclosure claims priority to Japanese Patent Application No.2022-026496 filed Feb. 24, 2022, which is incorporated herein by reference in its entirety including specification, drawings and claims.

### TECHNICAL FIELD

The present disclosure relates to a motor vehicle, and more particularly, to a motor vehicle that charges a power storage device mounted with electric power from an external power source.

### BACKGROUND

Conventionally, a motor vehicle of this type has been proposed that includes a power storage device and a charging device that performs external charging of the power storage device by receiving electric power from an external power source, and notifies a user of information related to charging (for example, refer to Patent Literature 1). In this vehicle, when an abnormality occurs while the power storage device is being charged with external electric power, the charging is stopped and the user is notified of the abnormality.

### CITATION LIST

### Patent Literature

PTL1: Japanese Patent Application Laid Open No. 2021-027687

### SUMMARY

In the above-described motor vehicle, when a cause of stopping the charging of the power storage device such as some abnormality occurs after the charging of the power storage device by the electric power from the external power source is started, the cause is specified and the user is notified of the cause. In the above-described motor vehicle, when the charging of the power storage device by the electric power from the external power source cannot be started due to some circumstances, the user, the dealer, the repair shop, and the like are not notified of the cause. Therefore, it is not possible to cope with a situation in which charging of the power storage device is not started.

An object of the present disclosure is to appropriately deal with a case where charging of a power storage device by the power from an external power source cannot be started.

In order to achieve the above primary object, the motor vehicle of the present disclosure employs the following configuration.

The motor vehicle of the present disclosure includes a power storage device, a charger that charges the power storage device by electric power from an external power source, and a control device that controls the charger, wherein the control device is programmed to acquire a charging start impossible factor that cannot start charging when the charging of the power storage device by the charger cannot be started.

The motor vehicle of the present disclosure includes a power storage device, a charger that charges the power storage device with electric power from an external power source, and a control device that controls the charger. When the charging of the power storage device by the charger cannot be started, the control device acquires a charging start impossible factor that cannot start the charging. As a result, the user, the dealer, the repair shop, and the like can obtain the acquired charging start impossible factor, and can appropriately cope with a situation in which the charging cannot be started.

Here, the charging start impossible factor includes at least a part of a line abnormality factor such as a standard mismatch factor in which the standard of the charger on the vehicle side and the power feeder on the external power supply side is different, a communication abnormality factor in which an abnormality occurs in communication between the vehicle side and the external power supply side, an abnormality in the power line for charging, and a vehicle side factor in which the vehicle side is not in a chargeable condition.

### BRIEF DESCRIPTION OF DRAWINGS

FIG. 1 is a configuration diagram schematically showing a configuration of a motor vehicle 20 as an embodiment of the present disclosure, and

FIG. 2 is a flowchart showing an example of a charging process executed by an electronic control unit 70.

### DESCRIPTION OF EMBODIMENTS

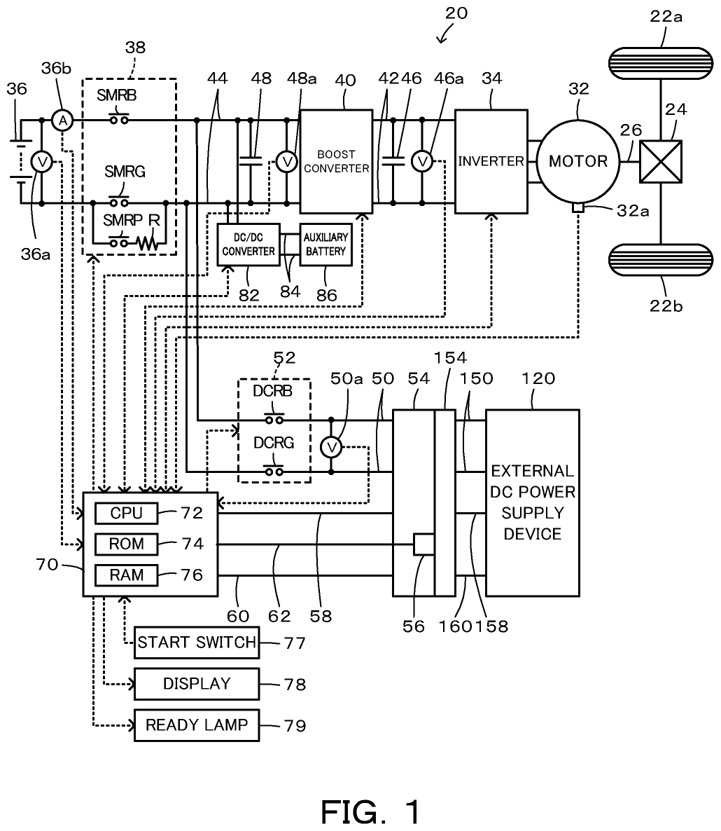

Next, an embodiment of the present disclosure will be described. FIG. 1 is a configuration diagram schematically showing a configuration of a motor vehicle 20 as an embodiment of the present disclosure. As shown in FIG. 1, the motor vehicle 20 of the embodiment includes a motor 32, an inverter 34, a battery 36, a boost converter 40, a high-voltage-side power line 42, a low-voltage-side power line 44, a system main relay 38, a charging power line 50, a vehicle-side inlet 54, and the electronic control unit 70.

The motor 32 is configured as a synchronous generator motor. The motor 32 includes a rotor in which a permanent magnet is embedded, and a stator in which a three-phase coil is wound. The rotor of the motor 32 is connected to a drive shaft 26 connected to the drive wheels 22a and 22b via a differential gear 24.

The inverter 34 is connected to the motor 32 and to the high voltage power line 42. The inverter 34 is configured as a well-known inverter circuit having six transistors and six diodes.

The battery 36 is configured as, for example, a lithium ion rechargeable battery or a nickel metal hydride battery. The battery 36 is connected to the low-voltage-side power line 44.

The boost converter 40 is connected to the high-voltage-side power line 42 and the low-voltage-side power line 44. The boost converter 40 is configured as a well-known step-up/step-down converter circuit having two transistors, two diodes, and a reactor.

A high-voltage-side capacitor 46 is connected to the positive-electrode bus and the negative-electrode bus of the high-voltage-side power line 42. A low-voltage-side capacitor 48 is attached to the positive-electrode bus and the negative-electrode bus of the low-voltage-side power line 44. A system main relay 38 is attached to the low-voltage-side power line 44. The system main relay 38 includes a positive-electrode-side relay SMRB provided on the positive-electrode bus of the low-voltage-side power line 44, a negative-electrode-side relay SMRG provided on the negative-electrode bus of the low-voltage-side power line 44, and a precharge circuit in which precharge resistor R and a precharge relay SMRP are connected in series so as to bypass the negative-electrode-side relay SMRG. The low-voltage-side power line 44 is connected to DC/DC converters 82 that exchange electric power with an auxiliary battery 86 and an auxiliary power line 84 to which an auxiliary device (not shown) is connected.

The charging power line 50 includes one end connected to the boost converter 40 side (motor 32 side) from the system main relay 38 of the low-voltage-side power line 44, and the other end connected to the vehicle-side inlet 54. A charging relay 52 is attached to the charging power line 50. The charging relay 52 includes a positive-electrode-side relay DCRB provided on the positive-electrode-side line of the charging power line 50 and a negative-electrode-side relay DCRG provided on the negative-electrode-side line of the charging power line 50. The charging power line 50 is connected to an external-side charging power line 150 from an external DC power supply device 120 by connecting an external-side connector 154 of the external DC power supply device 120 to the vehicle-side inlet 54. The external DC power supply device 120, not shown, is connected to an external commercial power supply. The external DC power supply device 120 converts power from the commercial power supply into DC power and supplies the DC power from the external-side charging power line 150.

When the external-side connector 154 is connected to the vehicle-side inlet 54, a connection line 58 connected to an external-side connection line 158 of the external DC power supply device 120 via the external-side connector 154, and a communication line 60 connected to an external-side communication line 160 connected to the external DC power supply device 120 via the external-side connector 154 are connected.

The electronic control unit 70 is configured as a microprocessor centered on CPU 72. In addition to CPU 72, the electronic control unit 70 includes a ROM 74 for storing a process program, a flash memory (not shown) for temporarily storing RAM 76, an input/output port (not shown), a communication port (not shown), and the like.

The electronic control unit 70 receives signals from various sensors via an input port. The signals inputted to the electronic control unit 70 include, for example, the rotational position θm from a rotational position detection sensor (e.g., resolver) 32a that detects the rotational position of the rotor of the motor 32, a voltage VB from a voltage sensor 36a mounted between the terminals of the battery 36, a current IB from the current IB from a sensor 36b mounted to an output terminal of the battery 36, a voltage VH of the high-voltage-side capacitor 46 (high-voltage-side power line 42) from a voltage sensor 46a mounted between the terminals of the high-voltage-side capacitor 46, a voltage VL of the low-voltage-side capacitor 48 (low-voltage-side power line 44) from a voltage sensor 48a mounted between the terminals of the low-voltage-side capacitor 48, and a charging voltage Vchg from a voltage sensor 50a mounted to the charging power line 50. The input port of the electronic control unit 70 is connected to a connection line 58 connected to the vehicle-side inlet 54 and a lid signal line 62 from a lid sensor 56 mounted to the vehicle-side inlet 54. Since the electronic control unit 70 also functions as a drive control device for the vehicle, information required for system activation and information necessary for travel control are also input. These pieces of information are, for example, a start signal from a start switch 77, a shift position from a shift position sensor that detects an operation position of a shift lever (not shown), an accelerator opening degree from an accelerator pedal position sensor that detects a depression amount of an accelerator pedal (not shown), a brake pedal position from a brake pedal position sensor that detects a depression amount of a brake pedal (not shown), and a vehicle speed from a vehicle speed sensor (not shown).

The electronic control unit 70 outputs various control signals via an output port. The signals outputted from the electronic control unit 70 are, for example, a switching control signal to the transistor of the inverter 34, a switching control signal to the transistor of the boost converter 40, a driving control signal to the system main relay 38, a driving control signal to the charging relay 52, a display signal to a display 78 disposed on the instrument panel in front of the driver's seat, a lighting signal to a ready lamp 79, a switching control signal to the transistor of DC/DC converter 82, and the like.

The electronic control unit 70 communicates with the external DC power supply device 120 by connecting the communication line 60 connected to the communication port to the external communication line 160.

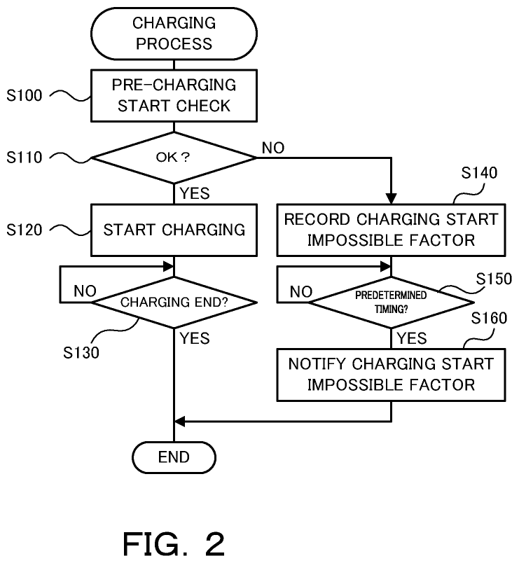

Next, the operation of the motor vehicle 20 of the embodiment thus configured, in particular, the operation when charging the battery 36 by the electric power from the external DC power supply device 120 will be described. FIG. 2 is a flowchart illustrating an example of a charging process executed by the electronic control unit 70 when the battery 36 is charged using electric power from the external DC power supply device 120. This charging process is executed when charging of the battery 36 is started. For example, the charging process is executed when the external-side connector 154 is connected to the vehicle-side inlet 54 to immediately start charging the battery 36, or when the charge start time is reserved after connecting the external-side connector 154 to the vehicle-side inlet 54, it is executed when the charging start time is reached and the battery 36 charge begins.

When the charging process is executed, the electronic control unit 70 first performs pre-charging start checking (step S100). The pre-charging start check includes, for example, check whether or not the vehicle-side charging standard, such as whether the standard of the vehicle-side inlet 54 and the standard of the external-side connector 154 match, and the power supply standard on the external-side DC power supply device 120 side match, check whether or not an abnormality has occurred in the communication between the electronic control unit 70 and the external-side DC power supply device 120 due to disconnection of the communication line 60 or disconnection of the external-side communication line 160, check whether or not an abnormality has occurred in the charging power line 50 or the external-side charging power line 150, and check whether or not the shift position SP is in a position other than the charging position (parking position: P position), or whether or not the vehicle side is in a chargeable state.

The electronic control unit 70, when it is determined that it can be charged by the pre-charging start check of the step S100 (step S110), starts charging the battery 36 using power from the external DC power supply device 120 (step S120), waits until the charging ends (step S130), and terminates the process.

When the electronic control unit 70 determines that charging is impossible by the pre-charging start check of the step S100 (step S110), it records a factor for which charging cannot be started (charging start impossible factor) (step S140). The charging start impossible factor, as described in the pre-charging start check, includes the standard mismatch factor in which the charging standard of the vehicle side and the power supply standard of the external-side DC power supply device 120 side do not match, the communication abnormality factor in which abnormality occurs in the communication between the electronic control unit 70 and the external-side DC power supply device 120, the line abnormality factor in which abnormality occurs in the charging power line 50 and the external-side charging power line 150, and the vehicle side factor in which the vehicle side is not in a chargeable state.

When the charging start impossible factor is recorded, the electronic control unit 70 waits for a predetermined timing (step S150), notifies the charging start impossible factor (step S160), and ends this process. The predetermined timing is a timing at which the external-side connector 154 is connected to the vehicle-side inlet 54 to immediately start charging the battery 36, and a timing at which the system of the vehicle is started next. Further, when the charging start time is reserved after the external-side connector 154 is connected to the vehicle-side inlet 54, the predetermined timing is a timing at which the system of the vehicle is started next after the charging start time is reached and the charging of the battery 36 is started up. The notification can be made by displaying the charging start impossible factor on the display 78 or outputting the charging start impossible factor by voice.

The electronic control unit 70 of the motor vehicle 20 according to the embodiment performs a pre-charging start check before starting the charging of the battery 36 using the electric power from the external DC power supply device 120, and when it is determined that the charging is impossible by the pre-charging start check, records a factor that the charging cannot be started (the charging start impossible factor). As a result, the user, the dealer, the repair shop, and the like can obtain the acquired the charging start impossible factor, and can appropriately cope with a situation in which the charging cannot be started. Moreover, since the electronic control unit 70 notifies the charging start impossible factor at a predetermined timing, it is possible to notify the user of the charging start impossible factor.

The electronic control unit 70 of the motor vehicle 20 according to the embodiment performs a pre-charging start check before starting the charging of the battery 36 using the electric power from the external DC power supply device 120, and when it is determined that the charging is impossible by the pre-charging start check, records a factor that the charging cannot be started (the charging start impossible factor). However, the electronic control unit 70 may not perform the pre-charge check. In this case, when the electronic control unit 70 tries to start the charging of the battery 36 but does not start the charging, it may record that the charging of the battery 36 cannot be started as the charging start impossible factor. In this case, the electronic control unit 70 may display “charging cannot be started” or the like on the display 78 or output sound as a notification of the charging start impossible factor.

In the motor vehicle 20 of the embodiment, the charging start impossible factor is notified at a predetermined timing after recording the charging start impossible factor, but the charging start impossible factor may not be notified.

In the motor vehicle 20 of the embodiment, the battery 36 is charged using the DC power from the external DC power supply device 120. However, the battery 36 may be charged using AC power from an external AC power supply device. In this case, a power conversion device that converts AC power to DC power of any voltage can be incorporated in the charging power line 50.

In the motor vehicle 20 of the embodiment, the battery 36 is used as the power storage device, but any device capable of storing power may be used, and a capacitor or the like may be used. Although the motor vehicle 20 of the embodiment includes the boost converter 40, the boost converter 40 may be omitted.

The embodiment is in the form of a motor vehicle 20 with a motor 32. However, a hybrid vehicle including an engine in addition to the motor 32 may be used, or a vehicle equipped with a fuel cell may be used.

In the motor vehicle of the present disclosure, when the charging start impossible factor is acquired, the control device may notify that the charging cannot be started at a predetermined timing or the acquired charging start impossible factor. In this way, the user can recognize that the charging cannot be started or the cause thereof. Here, the predetermined timing includes a timing immediately after the acquisition of the charging start impossible factor and a timing at which the vehicle is system-activated. The timing immediately after acquisition of the charging start impossible factor, when the user immediately starts charging of the power storage device by electric power from the external power supply immediately after acquiring the charging start impossible factor, by notifying at the timing immediately after acquisition of the charging start impossible factor, it is possible to recognize that the user can not immediately start charging or the factor. Further, in the case of performing charging by setting the charging start time, since it is found that it is not possible to start charging after the charging start time is reached and the factor, the next by notifying at a timing when the user is seated in the driver's seat and the vehicle is system-activated, it is possible to recognize more reliably that the user can not start charging or the factor.

The following describes the correspondence relationship between the primary components of the embodiment and the primary components of the disclosure described in Summary. In the embodiment, the battery 36 corresponds to the “power storage device”, the charging relay 52, the vehicle-side inlet 54, and the like correspond to the “charger”, and the electronic control unit 70 corresponds to the “control device”.

The correspondence relationship between the primary components of the embodiment and the primary components of the disclosure, regarding which the problem is described in Summary, should not be considered to limit the components of the disclosure, regarding which the problem is described in Summary, since the embodiment is only illustrative to specifically describes the aspects of the disclosure, regarding which the problem is described in Summary. In other words, the disclosure, regarding which the problem is described in Summary, should be interpreted on the basis of the description in the Summary, and the embodiment is only a specific example of the disclosure, regarding which the problem is described in Summary.

Although the embodiments of the present disclosure have been described above, the present disclosure is not limited to such embodiments, and can be implemented in various forms without departing from the gist of the present disclosure.

### INDUSTRIAL APPLICABILITY

The disclosure is applicable to, for example, the manufacturing industries of motor vehicle.

1. A motor vehicle comprising: a power storage device; a charger for charging the power storage device by electric power from an external power source; and a control device for controlling the charger;
wherein the control device is programmed to acquire a charging start impossible factor that cannot start charging when the charging of the power storage device by the charger cannot be started.

2. The motor vehicle according to claim 1,
wherein the control device is programmed to notify the charging could not be started at a predetermined timing and/or the acquired charging start impossible factor when the charging start impossible factor is acquired.

3. The motor vehicle according to claim 2,
wherein the predetermined timing is a timing immediately after the acquisition of the charging start impossible factor or a timing at which the vehicle is system-activated.

4. The motor vehicle according to claim 1,
wherein the charging start impossible factor includes at least a part of a line abnormality factor such as a standard mismatch factor in which a standard of a charger on a vehicle side and a power feeder on the external power source side is different, a communication abnormality factor in which an abnormality occurs in communication between the vehicle side and the external power source side, an abnormality in a power line for charging, and a vehicle side factor in which the vehicle side is not in a chargeable condition.
